(19) United States
(12) Patent Application Publication
(10) Pub. No.: US 2004/0138049 A1
(43) Pub. Date: Jul. 15, 2004

(54) Method and composition for solvent extraction of material from a molding

(75) Inventors: Mehrdad Yasrebi, Clackamas, OR (US); David Howard Sturgis, Boring, OR (US); Laxmappa Hosamani, Lafayette, CO (US); Brenda J. Schmidt, Aloha, OR (US)

Correspondence Address: KLARQUIST SPARKMAN, LLP, One World Trade Center, Suite 1600, 121 S.W. Salmon Street, Portland, OR, 97204, US

(73) Assignee: PCC Structurals, Inc.

(21) Appl. No.: 10/340,215

(22) Filed: Jan. 10, 2003

(51) Int. Cl. B29C 65/00; B29D 1/00; H05B 6/00; C04B 35/10

(52) U.S. Cl. 501/127; 264/42; 264/43; 264/49; 264/51

(57) ABSTRACT

The present disclosure describes improved compositions comprising an agitating agent, the compositions being particularly useful for powder injection molding. The disclosed method includes protocols for extracting binder materials from a powder injection molding prior to sintering. One embodiment of the disclosure includes compositions comprising a sinterable powder, a binder and a gas-forming agent. When induced to release a gas, the gas-forming agent provides internal agitation, which facilitates solvent-based binder extraction, resulting in a higher yield of extracted binder in reduced time. In one embodiment, the compositions include a carbonate, such as sodium carbonate, as the gas-forming agent. In this embodiment, the gas-forming agent is induced to form a gas during binder extraction by including an acid, such as citric acid, in the extraction solvent.

### FIELD

This disclosure concerns a composition useful for powder injection molding comprising an internal debinding agent, and a method for enhancing binder extraction from an article via internal agitation.

### BACKGROUND

Powder injection molding is a process used to form articles having relatively complex shapes. The process typically involves forming a die, selecting a suitable powder system, mixing the powder with a suitable binder system to produce a homogeneous mixture of the powder and the binder, and injection molding the mixture into the die to form an article having a desired shape. The binder material holds the powder system in the desired shape after the mold is removed from the die, at which time the binder material typically is removed from the article. The green body so formed is then sintered to provide a product article.

Powder injection molding is used industrially to mass-produce articles having consistent shapes and close dimensional tolerances. The process also minimizes time-consuming shaping and machining steps that are required to produce high-quality finished articles using other methods.

A long-standing problem associated with forming articles by injection molding concerns removing the binder from the article. The bulk of the binder should be removed before sintering. Removing binder directly during sintering typically results in serious stress-induced defects and deformation, and/or the inclusion of binder decomposition products, such as ash, in the product article.

Historically, binders have been removed from green bodies by a thermal degradation or “burn out” process. One example of such a process is described in U.S. Pat. No. 4,265,794, to Pett et al. The molded article may be deformed by binder burn out if the binder materials soften or melt before decomposing. Furthermore, many binders yield gaseous decomposition products, which may cause blistering and cracking of the article as the gas is evolved. The damage caused by such gas evolution depends on the rate of gas evolution and varies from article to article. To mitigate article deformation, thermal degradation protocols typically require careful temperature control and extended, time-consuming burn out periods. Burn out periods can take several days to complete, thereby causing significant delays in the production process.

Another drawback to thermal degradation processes is the production of decomposition products, such as carbon ash, that can be left behind in the article. Schofalvi et al. disclose a thermally degradable binder system in U.S. Pat. No. 6,204,316 (the '316 patent) and U.S. Pat. No. 6,376,585 (the '585 patent) that apparently degrades such that minimal ash and undesirable residues are left behind in the article. The '316 and '585 patents teach a polypropylene carbonate binder that decomposes to first form a cyclic propylene carbonate, which subsequently decomposes to propylene, carbon dioxide and water. This method purportedly avoids the deleterious effects associated with gas evolution directly from the injection molding during debinding.

A second method for binder removal is catalytic degradation, such as taught by Schofalvi et al. in the '585 patent. In this process, a “debinding accelerator” is included in the binder system for use in combination with polypropylene carbonate. At column 11, lines 44-49, Schofalvi et al. teach that the debinding accelerator is a free radical generator, such as a peroxide. The debinding accelerator presumably initiates radical depolymerization of the polypropylene carbonate.

Another process involves exposing binder to a decomposing atmosphere. One example of this approach is taught by Wingefeld et al. in U.S. Pat. No. 5,043,121 (the '121 patent). The '121 patent discloses an injection molding process comprising combining an acid-labile polyacetal binder comprised of repeating —OCH₂— units with ceramic powder to produce an injection-molded article. The injection-molded article is exposed to a gaseous mineral acid, such as hydrochloric acid to decompose the polyacetal binder before firing. Drawbacks of this catalytic degradation approach include the requirement for special equipment to remove formaldehyde, a known carcinogen, produced by the decomposition of the polyacetal binder, and the use of hazardous materials, such as strong, gaseous acids.

Solvent debinding is an alternative method for removing binders from powder injection molded articles. Solvent debinding was introduced to circumvent problems inherent in the burn out protocols described above. A general example of this method is described in U.S. Pat. No. 5,627,258 to Takayama et al. In this method, a binder system composed of at least a two component binder is used to form a molded article. A first binder component is soluble in a solvent, and a second binder component is preferably insoluble in the solvent. The molded article is subjected to solvent extraction to remove the soluble binder component, and subsequently the insoluble binder component is removed by thermal decomposition or sintering. In this process, removal of the soluble binder component leaves behind pores in the molded article. It is thought that such pores reduce debinding stress during subsequent removal of the insoluble, second component via thermal debinding or sintering. Various solvents have been used for solvent debinding, including organic solvents, such as acetone, methylethyl ketone, heptane, carbon tetrachloride, trichloroethylene, methylene chloride, and alternative solvents, such as supercritical carbon dioxide, and water. In general, solvent debinding reduces the debinding time to hours rather than days.

### SUMMARY

The present disclosure describes a feedstock composition and method that addresses problems associated with powder injection molding, particularly removing binder materials from a newly formed article or molding. The method offers several advantages, including eliminating or substantially reducing manufacturing delay by producing high quality articles more rapidly than prior methods.

One embodiment of the disclosure includes compositions comprising a sinterable powder, a binder and a gas-forming agent. According to this embodiment, the composition is molded into the shape of a desired article using techniques known to those of ordinary skill in the art. The gas-forming agent in the composition facilitates binder removal from an article by providing a source of internal agitation. The gas-forming agent can release a gas after initiation. The initiation can proceed by contacting the gas-forming agent with an initiator. For example, an initiator can be included in a solution for binder extraction, such that when the article contacts the solution, a gas is produced. Gas production from inside the article helps the binder dissolve into the solution, and increases the amount of binder extracted.

In one embodiment of a composition, the gas-forming agent is a carbonate, bicarbonate, or mixture thereof that reacts with an acidic initiator to produce carbon dioxide gas. For example, a working embodiment used sodium carbonate in the powder system as a gas-forming agent and the binder extraction solution included citric acid as an initiator.

A further advantage of embodiments of the present composition comprising a gas-forming agent is that the agent can act as a filler. Injection molding feedstocks useful for producing such refractory cores frequently contain volatile fillers used to tailor the permeability and porosity of sintered cores. Similarly, the gas-forming agent can be used as a filler resulting in increased porosity in an article after binder extraction. This property is particularly advantageous for producing refractory core bodies used in investment casting.

According to the present method, from about 1 percent to about 99 percent of the binder can be extracted prior to sintering. Typically at least about 30 percent of the binder is extracted and more typically at least about 40 percent of the binder is extracted. In certain embodiments more than about 70 percent of the binder is extracted.

### DETAILED DESCRIPTION

Without being limited to one theory of operation, extraction of soluble binder from an article is thought to proceed by the following mechanism. First, solvent molecules penetrate into the binder, producing a swollen gel. If the binder-solvent interactions are strong enough, the solvent dissolves the binder. The resulting solution then diffuses toward the surface, and finally away from the article. The rate-limiting step in the extraction process is thought to be the outward diffusion of dissolved binder. Slow outward diffusion can result in solvent saturation, which precludes further binder dissolution.

Methods to enhance binder extraction have been explored, including methods for increasing the initial rate of dissolution and for avoiding solvent saturation, such as extracting at elevated temperature, using large solvent volumes and solvent circulation. Elevated temperature extraction has several drawbacks. For example, high solvent temperature can cause article deformation. Furthermore, increasing solvent temperature actually may reduce binder dissolution if the temperature exceeds what is known as the upper theta temperature. Moreover, many commonly used organic solvents have relatively low flash points. Heating low flash point solvents can be hazardous, particularly in an industrial setting.

Additional techniques for increasing the rate of binder extraction include, for example, solvent circulation, solvent agitation, article agitation, or combinations of these techniques. Techniques for solvent circulation and agitation include using a nozzle to direct solvent onto articles, a pump to circulate solvent, and using ultrasonic agitation. These methods are commercially impractical, particularly when several articles must be processed at once. For example, uniform binder extraction using a nozzle to direct solvent may not be possible due to the complicated shape and fine features of complex articles. Similarly, it is difficult to simultaneously bring numerous articles into contact with a solvent agitated by a pump or by ultrasonic waves or to simultaneously agitate such articles directly. Therefore, a more effective method for enhancing binder extraction is necessary.

### I. Introduction

The present disclosure describes embodiments of a composition and method for forming articles using powder injection molding. The composition uses a gas-forming agent to provide internal agitation to facilitate binder removal from a formed article. The gas-forming agent is activated by an initiator provided in the extraction solution. The method provides superior molded articles in less time in comparison with prior art methods for extracting binder from a formed article. Furthermore the gas-forming agent can be used in combination with techniques such as those described above to provide superior results relative to known methods for binder removal.

### II. Particulate Material

Any sinterable particulate material or powder can be used in the compositions having a gas-forming agent. Typically, the sinterable particulate material comprises an inorganic material, including metallic, metal oxide, and/or intermetallic material. The material can comprise oxides or chalcogenides of metallic, intermetallic, or nonmetallic elements. Metallic elements that can be included in particulate materials include those selected from the group consisting of aluminum, calcium, magnesium, barium, scandium, titanium, vanadium, chromium, manganese, iron, cobalt, nickel, copper, zinc, yttrium, niobium, molybdenum, ruthenium, rhodium, silver, cadmium, actinium, gold, and physical and chemical combinations thereof.

In one embodiment the inorganic powder can contain a rare earth element. Rare earth elements include scandium, yttrium, and elements of the lanthanide series having atomic numbers from 57-71.

Ferromagnetic metals can be included in the inorganic powder. By way of example, ferromagnetic metals include those selected from the group consisting of iron, nickel, cobalt, and alloys thereof, including prealloyed powders, such as brass, bronze, and steel, including stainless steel. Other suitable prealloyed powders include superalloys. By way of example, such superalloys typically are based on Group VIIIB elements and comprise one or more of an element selected from the group consisting of iron, nickel, cobalt, chromium, tungsten, molybdenum, tantalum, niobium, titanium, and aluminum.

Inorganic particulate materials can comprise inorganic compounds of one or more of the metals listed above. Such compounds can be of a class selected from the group consisting of aluminides, oxides, hydroxides, sulfides, nitrides, borides, carbides, fluorides, ferrites and titanates. Specific examples are selected from the group consisting of ceramic powders, such as cordierite powders, alumina, silica, mullite, kyanite, zircon, zirconia, yttria, beryllia, magnesia, titania, chromium oxide, iron oxide, metal powders, such as titanium, iron, copper, aluminum, silicon, nickel, cobalt, intermetallics, such as titanium aluminide, titanium boride, tungsten carbide, silicon nitride and combinations thereof. Embodiments of particulate materials include materials from plural groups mentioned above, such as particulate materials comprising both at least one ceramic and at least one metal or intermetallic material.

Typically the sinterable powder including one or more components listed above comprises from about 30 volume percent to about 90 volume percent of the injection molding feedstock composition. More typically the sinterable powder comprises from about 50 to about 70 volume percent of the injection molding feedstock composition.

### III. Binder Systems

Binder systems typically include at least one material selected from the group of thermoplastic polymers, where “thermoplastic” refers to any material that can be shaped by applying heat or pressure. Any currently known or future developed binder can be used to form a suitable composition, and hence such composition can be used to practice the present method of binder removal. Binder extraction yield for all binders should be enhanced by using the gas-forming agent as a source of internal agitation. Thus an advantage of the present method for binder extraction is that any binder can be used, and thus the binder or combination of binders can be selected to be compatible with the particulate material chosen. In contrast, prior proposed solutions often required particular binders or restricted the selection of binders to a limited number.

Particular binder classes include, without limitation fluoroplastics, polyacetal, polyacrylate, polyamide, polyamide-imide, polyaryletherketone, polybutylene, polycarbonate, polyester, polyethersulfone, polyethylene, polyethylene halogenates, such as chlorinates, polyethyletherketone, polyimide, polyketone, polymethylpentene, polyphenylene sulfide, polyphthalimide, polypropylene, polystyrene, polyurethane, polyvinylchloride, polyvinylidene chloride, ethylene vinyl alcohol, polybutadiene, polyethylene vinyl acetate, silicone and combinations thereof.

Particular water soluble polymers suitable for use in embodiments of the present composition and method for powder injection molding include polyethylene oxide, polyethylene glycol, polypropylene glycol, polyvinyl alcohol, polyacrylamide, polyvinyl ether, polyvinylpyrrolidone, polyacrylic acid, polymethacrylate, polyphosphoric acid, polystyrene sulfonic acid, polyethyleneimine, polyvinylamine, poly-4-vinylpyridine. Further examples of water soluble polymers include saccharide derivatives, such as monosaccharide-modified polymers, oligosaccharides, polysaccharides, and derivatives thereof, such as methyl cellulose, carboxymethyl cellulose and starch.

In addition to the primary binder system components described above, the binder system also can comprise additional materials, such as lubricants, plasticizers, dispersants, and anti-oxidants. By way of example, such materials can include polymers, such as those listed above, having a molecular weight below their entanglement molecular weight, stearic acid, antipyrine, palm oil, acetanilide, and synthetic and natural waxes such as paraffin wax, carnauba wax and candellia wax. Typically the binder system including the above components comprises from about 10 volume percent to about 70 volume percent of the injection molding feedstock composition. More typically the binder system comprises from about 30 to about 50 volume percent injection molding feedstock composition. Typically, the additional materials described above, such as dispersants, comprise from about 0.1 volume percent to about 5 volume percent of the injection molding feedstock composition.

### IV. Gas-forming Agents and Activating Agents

According to described embodiments of the composition and method, a gas-forming agent is included in an injection-molded part to enhance binder extraction. The gas-forming agent is selected such that it can be induced to release a gas. Moreover, the gas-forming agent is particularly selected to release a gas when contacted by an activating agent or when particular conditions, such as radiation, temperature and/or pressure, are varied as appropriate to result in gas production. The activating agent can function catalytically or stoichiometrically to initiate gas evolution.

Any gas-forming agent can be used, including those that produce a gas selected from the group consisting of acetylene, ethylene, propylene, butadiene, ethane, methane, carbon dioxide, carbon monoxide, hydrogen, nitrogen, ammonia, oxygen, and combinations thereof.

Any solvent can be used for binder extraction according to the present method. Typical solvents include water and aqueous solvent mixtures, such as water mixed with an organic solvent. Thus, organic solvents can be used alone or as cosolvents with water to extract binder. Typical examples of organic solvents used for binder extraction include selected from the group consisting of acetone, methanol, ethanol, isopropanol, dimethylformamide, hexanes, N-methylacetamide, N-methylpyrrolidone, tetrahydrofuran, and combinations thereof. The temperature of the solvent used for extraction is below about the solvent's vaporization temperature at a given pressure. Typically this temperature is below about 200° C. Typically the gas forming reagent forms a gas, decomposes, and/or vaporizes below about the temperature of the solvent being used for binder extraction. Similarly, the gas formed has a vaporization temperature of below about the same temperature. Particular gases produced are selected from the hydrocarbon gases, such as hydrocarbon gases produced by depolymerization of a polymer to give a volatile depolymerization product. Classes of gas-forming agents include those selected from the group consisting of metals, carbonates, carbonyl compounds, hydrides, nitrides, azides, peroxides, and combinations thereof. Particular gas-forming metals include metals that release hydrogen upon contact with an acid, such as lithium, sodium, potassium, calcium, magnesium, chromium, manganese, iron, cobalt, and the like. Particular gas-forming agents include metal carbonates, metal bicarbonates, Group I carbonates, Group II carbonates, Group I bicarbonates, Group II bicarbonates, Group I metals, Group II metals, and combinations thereof.

The gas-forming agent can comprise from about 0.1 percent to about 80 volume percent of the injection molding feedstock composition. Typically the gas-forming agent comprises from about 1 to about 15 volume percent and more typically from about 1 to about 10 volume percent of the injection molding feedstock composition. Working embodiments use an injection molding composition having between about 1 and about 5 volume percent gas-forming agent. When the gas-forming agent is used as a filler, the percentage of gas-forming agent can be selected based upon the desired degree of permeability or porosity.

Activating agents generally are selected to complement gas-forming agents. The activating agent can be any agent that induces a gas-forming agent to release a gas or reacts catalytically or stoichiometrically with a gas-forming agent to produce a gas. For example, gas formation can be induced or modulated by light, heat, a reagent or combinations thereof. Typically the activating agent is soluble in the particular extraction solvent being used, so that the activating agent can be added in solution with the extraction solvent. Although any activating agent can be used, working examples are described below which use, by way of example, an acid to initiate gas evolution. Any acid that results in gas production can be used, including without limitation, Lewis acids and protic acids, weak acids and strong acids, such as mineral acids. Particular examples of mineral acids include hydrochloric acid, hydrobromic acid, phosphoric acid, sulfuric acid, nitric acid and the like. Additional protic acids include organic acids, such as citric, tartaric, acetic, formic, oxalic, benzoic, malonic, succinic, adipic, phthalic, and like acids.

An advantage of the present molding compositions is that the gas-forming agent can act as a filler material. This feature is particularly useful in the production of refractory core bodies used in investment casting. Injection molding feedstocks used for producing such refractory cores frequently contain volatile filler agents that are used to tailor the permeability and porosity of the sintered cores. The gas-forming agent can be used to accelerate binder extraction and simultaneously act as a filler to provide a desired degree of porosity in a refractory core. Without limitation to theory, it currently is believed that dispersion of the gas-forming agent as a powder in the binder system results in larger pores than dissolution of the gas-forming agent into the binder system.

### EXAMPLES

The following examples are provided to illustrate certain particular embodiments of the disclosure. It should be understood that additional embodiments not limited to these particular features described are consistent with the following examples and are within the scope of applicants' invention.

### Example 1

This example describes the preparation of sample green bodies containing a gas-forming agent. Dry ingredients were mixed in a stainless steel beaker in the amounts indicated in Table 1. The beaker was heated and the binders melted. The mixture was stirred with an overhead mixer, while maintaining the temperature of the feedstock at approximately 130-140° C. When the feedstock became uniform, the hot material was pressed using a die at 5,000 psi in the shape of a disk having a diameter of 1.25 inches.

With reference to Table 1, Recipe A includes NaHCO₃ as a gas-forming agent, Recipe B does not include a gas-forming agent, and hence acts as a control for the following trials, and Recipe C includes Na₂CO₃ as a gas-forming agent. With reference to Table 1, the binder system in Recipes A, B and C includes stearic acid, Wacker resin, polyethylene, and polyethylene glycol (PEG 3350). The powder system in Recipes A, B and C includes alumina in three different mesh sizes (325, 500, and 900 mesh) as indicated.

TABLE 1

| | Recipe A | Recipe B | Recipe C |
|---|---|---|---|
| Material | (grams) | (grams) | (grams) |
| Alumina - 325 Mesh | 54.7 | 54.7 | 54.7 |
| Alumina - 500 Mesh | 10.7 | 10.7 | 10.7 |
| Alumina - 900 Mesh | 32.2 | 32.2 | 32.2 |
| Stearic Acid | 4.6 | 4.6 | 4.6 |
| Wacker Resin | 8.0 | 8.0 | 8.0 |
| Polyethylene | 4.1 | 4.1 | 4.1 |
| PEG 3350 | 16.2 | 18.0 | 16.2 |
| NaHCO₃ | 3.2 | — | — |
| Na₂CO₃ | — | — | 3.2 |
| Total | 133.7 | 132.3 | 133.7 |
| Weight % of PEG | 12.1 | 13.6 | 12.1 |

### Example 2

This example describes sample leaching to compare the efficiency of binder removal for compositions A and B of Table 1. Three samples of each composition A and B, prepared according to Example 1, were submerged in 40° C. deionized water continuously stirred with a one-inch magnetic stirrer. Samples having composition A were extracted in deionized water having 2.5% by weight citric acid, and those having composition B were extracted in deionized water. The extracted samples were then dried at 35° C. for 24 hours, and their weights were compared to their initial, pre-extraction weights to determine percentage PEG extracted. The extraction results shown in Table 2 indicate that more binder is extracted and that binder is extracted at a higher rate from samples having Recipe A including NaHCO₃ than from control samples having Recipe B.

TABLE 2

| Time | | % PEG | | % PEG |
|---|---|---|---|---|
| (hours) | Sample | extracted | Sample | extracted |
| 2.5 | A-1 | 37.1 | B-1 | 25.7 |
| 5 | A-2 | 48.1 | B-2 | 35 |
| 18 | A-3 | 78.2 | B-3 | 37.9 |

### Example 3

This Example demonstrates that NaHCO₃ acts as an internal agitating agent. In this Example samples of compositions A and B were prepared as described in Example 1, and extracted using two different extraction solutions having different concentrations of citric acid. With reference to Table 3, a sample of composition A and a sample of composition B were placed in the same beaker maintained at 40° C., without stirring, for 2.5 hours. The results recorded in Table 3 indicate that NaHCO₃ accelerates extraction independent of external agitation, and that increasing citric acid concentration also increases the binder extraction yield.

TABLE 3

| Weight % | | A % PEG | | B % PEG |
|---|---|---|---|---|
| Citric Acid | Sample | Extracted | Sample | Extracted |
| 2.5 | A-4 | 33.8 | B-4 | 15.1 |
| 5 | A-5 | 39.6 | B-5 | 17 |

### Example 4

This example describes binder extraction from samples of each composition. Samples A-6 (including NaHCO₃), B-6 (control), and C-1 (including Na₂CO₃), were leached side-by-side in the same 2.5% by weight citric acid solution, and samples A-7 (including NaHCO₃), B-7 (control), and C-2 (including Na₂CO₃) were leached side by side in the same 5% by weight citric acid solution. The samples were extracted at 40°C., without stirring, for 2.5 hours.

As shown in Table 4, extraction proceeds more slowly for samples having composition C than for those of composition A, but more quickly than for samples having composition B. This indicates that Na₂CO₃ accelerates binder extraction, but also indicates that Na₂CO₃ gives a slower binder extraction rate than NaHCO₃, likely because Na₂CO₃ evolves gas more slowly than NaHCO₃.

TABLE 4

| Weight % | Sam- | % PEG | Sam- | % PEG | | % PEG |
|---|---|---|---|---|---|---|
| Citric Acid | ple | Extracted | ple | Extracted | Sample | Extracted |
| 2.5 | A-6 | 33.6 | B-6 | 15.9 | C-1 | 26 |
| 5 | A-7 | 37.9 | B-7 | 15.7 | C-2 | 26.3 |

### Example 5

This example concerns sintering compositions A and B described in Example 1 above. Leached samples A-3 and B-3 were sintered in a CM Furnace equipped with a digital temperature controller. The furnace was heated from room temperature to 150° C. over a total time of 30 minutes at a ramp rate of 5° C./min, then from 150° C. to 400° C. over a total time of 125 minutes at a ramp rate of 2° C./min, and from 400° C. to 1,200° C. over a total time of 160 minutes at a ramp rate of 5° C./min.

The sample disks were measured before and after sintering, and the results are recorded in Table 5. The results recorded in Table 5 indicate that articles produced according to the present method and composition exhibit less shrinkage during sintering.

TABLE 5

| | |
|---|---|
| Diameter Before Leaching | Diameter After Sintering |

| Sample | Diameter | Diameter | % Shrinkage |
|---|---|---|---|
| A-3 | 1.25 inches | 1.225 | −2% |
| B-3 | 1.25 inches | 1.215 | −2.8% |

Without limitation to theory, it is believed that percent shrinkage indicates that NaHCO₃ acts as a filler material, and reduces the overall product shrinkage. It is believed that the overall product shrinkage is reduced by using a gas-forming agent because the agent leaves behind large, difficult-to-densify pores after removal. An additional advantage of the gas-forming agent acting as a filler is that it can be used to tailor a product, injection-molded article's porosity for use in various applications, such as a refractory body for investment casting.

Typically the product shrinks less than about 70 percent relative to the green body during sintering. More typically the product shrinks less than about 25 percent relative the green body. In one working embodiment the observed shrinkage was less than 3 percent, and in a second working embodiment the observed shrinkage was less than about 2.5 percent for the product as compared to the green body.

The present invention has been described with reference to preferred embodiments. Other embodiments of the invention will be apparent to those of ordinary skill in the art from a consideration of this specification, or practice of the invention disclosed herein. It is intended that the specification and examples be considered as exemplary only, with the true scope and spirit of the invention being indicated by the following claims.

We claim:

1. A powder injection molding composition, comprising:
a sinterable powder;
a binder; and
a gas-forming agent.

2. The composition according to claim 1 where the gas-forming agent releases a gas upon contact with an initiator.

3. The composition according to claim 1 where the gas-forming agent is selected from the group consisting of metal carbonates, metal bicarbonates, group I carbonates, group II carbonates, group I bicarbonates, group II bicarbonates, group I metals, group II metals, and combinations thereof.

4. The composition according to claim 1 where the gas-forming agent is selected from the group consisting of metal bicarbonates, group I carbonates, and combinations thereof.

5. The composition according to claim 1 where the binder is a component in a binder system.

6. The composition according to claim 1 where the gas-forming agent comprises from about 0.1% to about 60% of the composition.

7. The composition according to claim 1 where the gas-forming agent comprises from about 1% to about 10% of the composition.

8. The composition according to claim 1 where the gas-forming agent comprises from about 2% to about 5% of the composition.

9. The composition according to claim 1 where the sinterable powder comprises from about 30% to about 90% of the composition.

10. The composition according to claim 1 where the binder comprises from about from about 50% to about 70% of the composition.

11. The composition according to claim 1 where the binder comprises from about 10% to about 70% of the composition.

12. The composition according to claim 1 where the binder comprises from about 30% to about 50% of the composition.

13. The composition according to claim 2 where the initiator is an acid.

14. The composition according to claim 3 where the gas-forming agent is sodium carbonate, sodium bicarbonate, or combinations thereof.

15. A powder injection molding composition, comprising:
an inorganic powder;
a binder; and
a gas-forming agent selected from the group consisting of metal bicarbonates, group I bicarbonates, metal carbonates, metal bicarbonates and combinations thereof.

16. The composition according to claim 15 where gas evolution by the gas-forming agent is induced using an initiator.

17. The composition according to claim 15 where the initiator is an acid.

18. The composition according to claim 15 where the binder is a component in a binder system.

19. The composition according to claim 18 where at least one component of the binder system is water soluble.

20. The composition according to claim 15 where the gas-forming agent comprises a bicarbonate.

21. The composition according to claim 15 where the gas-forming agent comprises from about 0.1% to about 60% of the composition.

22. The composition according to claim 15 where the gas-forming agent comprises from about 1% to about 5% of the composition.

23. The composition according to claim 15 where the inorganic powder comprises from about 30% to about 90% of the composition.

24. The composition according to claim 15 where the inorganic powder comprises from about 50% to about 70% of the composition.

25. The composition according to claim 15 where the binder comprises from about 10% to about 70% of the composition.

26. The composition according to claim 18 where the binder system comprises polyethylene glycol.

27. A method for removing a material from a powder injection molding, comprising:
providing a molding containing the material and an activatable gas-forming agent;
initiating gas evolution using an activating agent; and
extracting the material from the molding.

28. The method according to claim 27 where the material comprises a binder.

29. The method according to claim 27 where the activating agent is an acid.

30. The method according to claim 27 where the gas-forming agent is selected from the group consisting of metal bicarbonates, group I carbonates, group II carbonates, group I metals, group II metals, and combinations thereof.

31. The method according to claim 27 where the gas-forming agent comprises carbonate, bicarbonate, or both.

32. The method according to claim 27 further comprising sintering the molding.

33. The method according to claim 32 where the molding shrinks less than about 70% during sintering.

34. The method according to claim 32 where the molding shrinks less than about 25% during sintering.

35. The method according to claim 32 where the molding shrinks less than about 2.5% during sintering.

36. The method according to claim 27 where the gas-forming agent is present in an amount sufficient to provide a desired porosity.

37. A method for forming a molding, comprising:
providing an inorganic powder;
providing a binder;
providing a gas-forming agent;
forming the inorganic powder, binder and gas-forming agent into a desired green body;
contacting the molding with a solution comprising an activating agent, thereby inducing the gas-forming agent to form a gas; and
extracting the binder into the solution.

38. The method according to claim 37 where the gas is selected from the group consisting of acetylene, ethylene, propylene, butadiene, ethane, methane, carbon dioxide, carbon monoxide, hydrogen, nitrogen, ammonia, oxygen, and combinations thereof.

39. The method according to claim 37 where the activating agent is an acid.

40. The method according to claim 37 where the gas-forming agent comprises carbonate, bicarbonate, or both.

41. The method according to claim 40 where the gas-forming agent comprises sodium bicarbonate.

42. The method according to claim 37 where at from about 1% to about 99% of the binder is extracted.

43. The method according to claim 37 where at least about 30% of the binder is extracted.

44. The method according to claim 37 where at least about 40% of the binder is extracted.

45. The method according to claim 37 where at least about 70% of the binder is extracted.

46. The method according to claim 37 further comprising externally agitating the solution.

47. The method according to claim 46 where externally agitating the solution includes providing ultrasonic agitation.
